(19) United States
(12) Patent Application Publication
(10) Pub. No.: US 2005/0269393 A1
(43) Pub. Date: Dec. 8, 2005

(54) Calculator capable of repeatedly pronouncing previous input data and method of repeatedly pronouncing the same

(75) Inventor: Ming-Chih Chen, Taipei County (TW)

Correspondence Address: BACON & THOMAS, PLLC, 625 SLATERS LANE, FOURTH FLOOR, ALEXANDRIA, VA, 22314, US

(73) Assignee: Kinpo Electronics, Inc., Taipei (TW)

(21) Appl. No.: 10/862,419

(22) Filed: Jun. 8, 2004

(51) Int. Cl. G06F 1/00

(52) U.S. Cl. 235/61 R

(57) ABSTRACT

A calculator comprises a keypad including a plurality of operation keys operable to generate a plurality of operands and operators, at least one shift key, a correction key, and a voice repeat key operable to generate a voice repeat control signal; a microprocessor for receiving the operands and the operators from the keypad and performing an operation thereon so as to obtain a result; a first memory module for storing the operands, the operators, and the result and showing the same on a display; and a voice module coupled to the microprocessor. The microprocessor can receive the voice repeat control signal for activating the voice module such that the voice module can pronounce the operands and the operators at least one time.

### BACKGROUND OF THE INVENTION

1. Field of the Invention

The present invention relates to calculators and, more particularly, to a calculator capable of repeatedly pronouncing previous input data including operators and operands and method of repeatedly pronouncing the same.

2. Description of Related Art

Features of calculator are more powerful as a result of technological advancements. For example, a conventional calculator can only perform a number of basic arithmetic operations including addition, subtraction, multiplication, and division. Nowadays, other than some calculation intensive calculators, many general calculators also have additional features for meeting the needs of vast users.

Currently, some calculators have a correction feature. For example, a user may carelessly key in “1+2+3+3+5=14” instead of the correct “1+2+3+4+5=15”. The user can use Backspace key, Up key or Down key, and Correction key to correct the typing mistake (e.g., “3”) as “4”.

However, such is not convenient for those persons performing operations by watching long financial lists. For example, a person may review previous input data (e.g., about at least 20 records) for correction if such is necessary. For reviewing, the person has to switch eyesight between the lists and the display frequently. This tends to cause human error(s) and eye fatigue.

Therefore, it is desirable to provide a novel calculator in order to mitigate and/or obviate the aforementioned problems.

### SUMMARY OF THE INVENTION

An object of the present invention is to provide a powerful calculator capable of repeatedly pronouncing previous input data so that a user can easily review input data and result for correction if such is necessary.

In one aspect of the present invention, there is provided a calculator capable of repeatedly pronouncing previous input data, comprising a keypad including a plurality of operation keys operable to generate a plurality of operands and operators, and a voice repeat key operable to generate a voice repeat control signal; a microprocessor for receiving the operands and the operators from the keypad and performing an operation thereon so as to obtain a result; a first memory module for storing the operands, the operators, and the result and showing the same on a display; and a voice module coupled to the microprocessor, wherein the microprocessor is operative to receive the voice repeat control signal for activating the voice module such that the voice module is operative to pronounce the operands and the operators stored in the first memory module.

In another aspect of the present invention, there is provided a method of enabling a calculator to repeatedly pronounce previous input data, comprising the steps of inputting a plurality of operands and operators; showing the operands and the operators; performing an operation on the operands and the operators for obtaining a result; storing the operands, the operators, and the result in memory means; and pronouncing the operands, the operators, and the result at least one time prior to a possible correction.

Other objects, advantages, and novel features of the present invention will become more apparent from the detailed description when taken in conjunction with the accompanying drawings.

### BRIEF DESCRIPTION OF THE DRAWINGS

FIG. 1 is a schematic block diagram of a calculator capable of repeatedly pronouncing previous input data according to the present invention;

FIG. 2 is a flow chart according to a first preferred embodiment of the present invention;

FIG. 3 is a flow chart according to a second preferred embodiment of the present invention; and

FIG. 4 is a flow chart according to a third preferred embodiment of the present invention.

### DETAILED DESCRIPTION OF THE PREFERRED EMBODIMENT

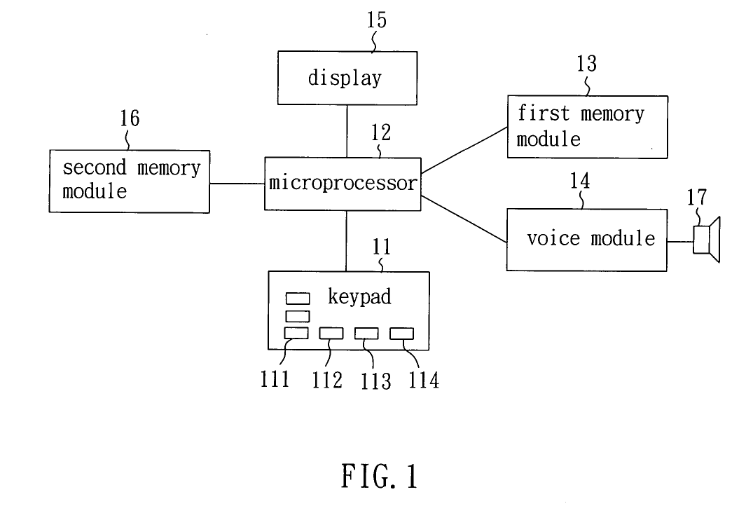

With reference to FIG. 1, there is shown a calculator capable of repeatedly pronouncing previous input data in accordance with the present invention. The calculator comprises a keypad 11, a microprocessor 12, a first memory module 13, a voice module 14, a display 15, and a second memory module 16. Each component will be described in detail below.

The keypad 11 comprises a plurality of operation keys 111, a first Shift key 112, a second Shift key 113, and a voice repeat key 114. Preferably, the first memory module 13 is a RAM (random access memory) for storing operators and operands inputted by the keypad 11. Preferably, the second memory module 16 is a ROM (read only memory) for permanently storing software or firmware of the calculator of the invention. Preferably, the operation keys 111 comprise numeric keys and operator keys. Preferably, the first Shift key 112 is a Left key (or Up key). Preferably, the second Shift key 113 is a Right key (or Down key).

The microprocessor 12 is coupled to the keypad 11, the first memory module 13, the voice module 14, the display 15, and the second memory module 16 respectively. A user may press the operation key 111 to generate a corresponding operand or operator (e.g., “+” or “−”). Also, a user may press the voice repeat key 114 to generate a voice repeat control signal which in cooperation with the microprocessor 12 can enable the voice module 14 to pronounce previous input data temporarily stored in the first memory module 13. Operations of the above components are illustrated in the following flow charts of three preferred embodiments of the invention.

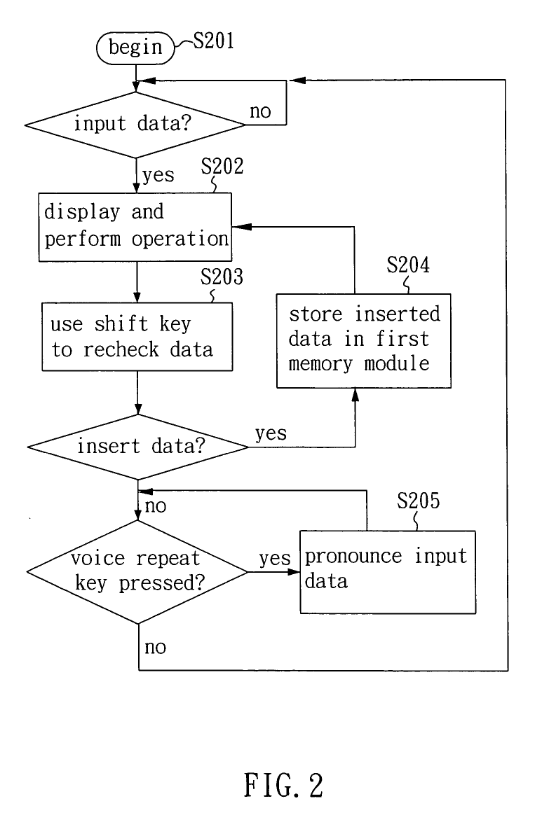

With reference to FIG. 2, there is shown a flow chart according to a first preferred embodiment of the invention. In step S201, a user turns on the calculator and begins to input data including operators and operands by continually pressing the operation key 111. The microprocessor 12 stores the input operators and operands in the first memory module 13. Further, it is determined whether there is new input data by polling or interrupt. The microprocessor 12 may display them on the display 15 and perform an operation thereon if at least two operands and one operator have been inputted (e.g., “2+3”). Next, a result of the operation is shown on the display 15 (step S202).

It is quite often that typing mistakes may occur in keying in data. For example, many operators and operands are required to input in a long list for calculation. For reviewing, a user may use the first Shift key 112 (e.g., forward) and the second Shift key 113 (e.g., backspace) to move a cursor on the display 15 for inserting new operator(s) or operand(s) in the previously inputted data (step S203). Next, the microprocessor 12 determines whether there is any new input data from the keypad 11. If yes, the microprocessor 12 stores the same in the first memory module 13 (step S204). Next, the new input data is shown along with the old input data on the display 15 and an operation is performed thereon again. A result of the operation is then shown on the display 15 (step S202).

A user may manipulate the first Shift key 112 and the second Shift key 113 for inserting new data in the previously inputted data if there is at least one typing mistake. The microprocessor 12 continues to detect whether the keypad 11 is pressed or not if there is no new data. A pressing of the voice repeat key 114 will generate a voice repeat control signal, which is then sent to the microprocessor 12. Next, the microprocessor 12 activates the voice module 14 to pronounce the input operators and operands by a speaker 17. This enables a user to concentrate attention on comparing data of the list with the pronounced data (step S205). Further, a user may listen the pronounced data again by pressing the voice repeat key 114 if he/she did not hear the previously pronounced data clearly due to lack of attention or other reasons. Such voice output technique can ensure a correct input. The microprocessor 12 will continue to detect whether the keypad 11 is pressed or not if pressing of the voice repeat key 114 is not detected.

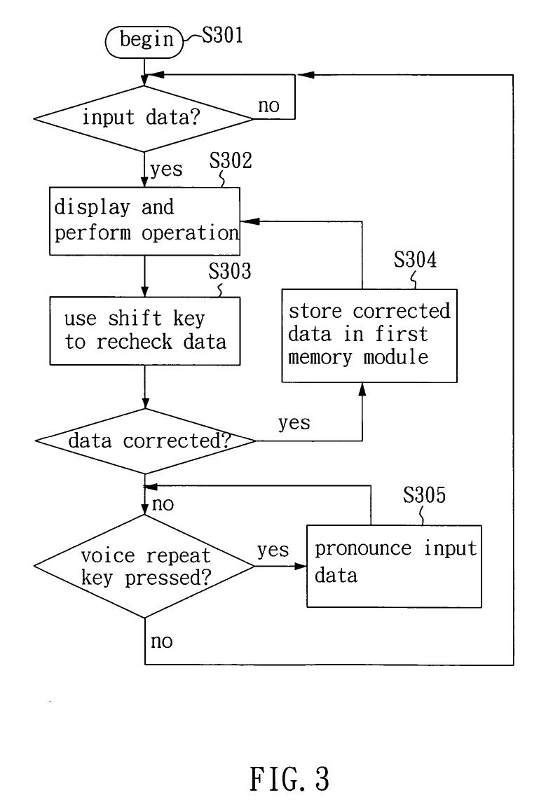

With reference to FIG. 3, there is shown a flow chart according to a second preferred embodiment of the present invention. The second preferred embodiment substantially has same method steps including steps S301, S302, S303, and S305 as that including steps S201, S202, S203, and S205 of the first preferred embodiment. The differences between the first and the second preferred embodiments, i.e., the characteristics of the second preferred embodiment are detailed below. For reviewing, a user may use the first Shift key 112 and the second Shift key 113 to move a cursor on the display 15 for correcting the previously inputted data if at least one typing mistake has been found. Further, the corrected data is stored in the first memory module 13 (step S304) prior to looping back to step S302.

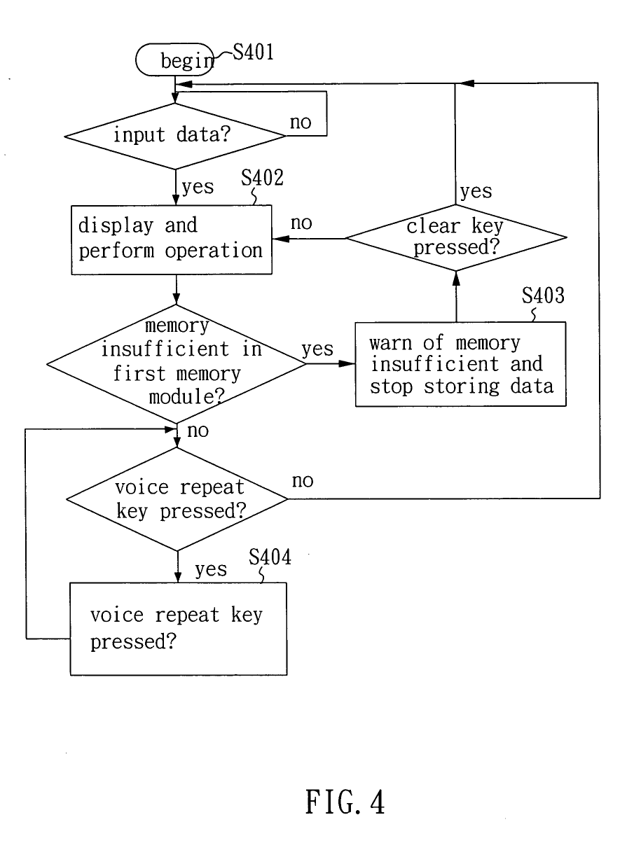

With reference to FIG. 4, there is shown a flow chart according to a third preferred embodiment of the present invention. The third preferred embodiment substantially has the same method steps including steps S401, S402 and S404 as that including steps S201, S202 and S205 of the first preferred embodiment. The differences between the first and the third preferred embodiments, i.e., the characteristics of the third preferred embodiment are detailed below. After the microprocessor 12 has performed an operation on operators and operands stored in the first memory module 13 and has sent a result on the display 15 for showing (step S402), the microprocessor 12 then issues a message of insufficient memory on the display 15 by, for example, flashing an icon of the display 15 if the memory space of the first memory module 13 is not sufficient, and further, stops storing operators and/or operands in the first memory module 13 (step S403).

In response to observing the message of insufficient memory on the display 15, a user may or may not press a clear key (e.g., AC key or C key). A calculation can be performed again if the operators and operands stored in the first memory module 13 are cleared. That is, new operators and/or operands are entered. Alternatively, the microprocessor 12 may perform an operation on the operators and operands stored in the first memory module 13 if they are not cleared. Either action will be determined immediately. Next, as stated above, a user may press the voice repeat key 114 to enable the voice module 14 to pronounce the operators and operands stored in the first memory module 13.

The microprocessor 12 may command the display 15 to sequentially show the operator or the operand stored in the first memory module 13 being pronounced by the voice module 14 in any of the above embodiments. Of course, a user may press the voice repeat key 114 prior to pressing the operator or operand for achieving the pronunciation in real time. Alternatively, the voice repeat key 114 is pressed for achieving pronunciation one at a time after has finished input of one record of data. Alternatively, the voice repeat key 114 is pressed again for achieving a number of continuous pronunciations after the calculation. As such, a user can easily review input data and result for correction if such is necessary. As a result, a powerful calculator is obtained.

Although the present invention has been explained in relation to its preferred embodiment, it is to be understood that many other possible modifications and variations can be made without departing from the spirit and scope of the present invention as hereinafter claimed.

1. A calculator capable of repeatedly pronouncing previous input data, comprising:
a keypad including a plurality of operation keys operable to generate a plurality of operands and operators, and a voice repeat key operable to generate a voice repeat control signal;
a microprocessor for receiving the operands and the operators from the keypad and performing an operation thereon so as to obtain a result;
a first memory module for storing the operands, the operators, and the result and showing the same on a display; and
a voice module coupled to the microprocessor,
wherein the microprocessor is operative to receive the voice repeat control signal for activating the voice module such that the voice module is operative to pronounce the operands and the operators stored in the first memory module.

2. The calculator as claimed in claim 1, wherein in response to pressing the voice repeat key, the microprocessor activates the voice module to pronounce the operands and the operators stored in the first memory module and performs an operation on the operands and the operators stored in the first memory module.

3. The calculator as claimed in claim 1, wherein the keypad further comprises at least one shift key and a correction key such that in response to pressing the voice repeat key and pronouncing the operands and the operators stored in the first memory module, the at least one shift key and the correction key are operative to correct at least one typing mistake in the operands and the operators.

4. A method of enabling a calculator to repeatedly pronounce previous input data, comprising the steps of:
inputting a plurality of operands and operators;
showing the operands and the operators;
performing an operation on the operands and the operators for obtaining a result;
storing the operands, the operators, and the result in memory means; and
pronouncing the operands, the operators, and the result prior to a possible correction.

5. The method as claimed in claim 4, wherein the pronunciation step is operative to perform a plurality of times.
